(19) United States
(12) Patent Application Publication
(10) Pub. No.: US 2008/0298075 A1
(43) Pub. Date: Dec. 4, 2008

(54) Lamp holder structure

(75) Inventors: Jui-Tsung Liao, San Chung City (TW); Yuan-Cheng Chin, San Chung City (TW)

Correspondence Address: TROXELL LAW OFFICE PLLC, SUITE 1404, 5205 LEESBURG PIKE, FALLS CHURCH, VA, 22041, US

(73) Assignee: Unity Opto technology Co., Ltd.

(21) Appl. No.: 11/806,249

(22) Filed: May 30, 2007

(51) Int. Cl. F21V 15/00; F21V 29/00

(52) U.S. Cl. 362/373; 362/362

(57) ABSTRACT

A lamp holder structure of the present invention is comprised of: a cup-shaped base; a circuit board and two elastic conducting devices mounted inside the cup-shaped base; and at least one light-emitting device mounted on the circuit board, wherein first ends of the elastic conducting devices are mounted under the circuit board for connection with the circuit board, and second ends of the elastic conducting devices are extended outside of the cup-shaped base, whereby the lamp holder structure can be supplied with electric power via the elastic conducting devices for providing illumination.

### FIELD OF THE INVENTION

The present invention relates to a lamp holder structure that has elastic conducting devices, and more particularly to a lamp holder structure for a light-emitting diode or a light bulb.

### BACKGROUND OF THE INVENTION

Typically, a lamp holder has a circuit board mounted therein, and a light-emitting device such as a light-emitting diode or a lamp bulb is electrically mounted on the circuit board, wherein an electronic device is mounted on the circuit board that connects with anode and cathode conducting wires. The anode and cathode conducting wires are weld-bonded to a power cord after penetrating through holes formed on the circuit board for thereby supplying the lamp holder with the required electric power.

However, the lamp holder is supplied with the required electric power by weld-bonding the power cord with the anode and cathode conducting wires that connect with the circuit board. But, the weld-bonding may be damaged or broken easily by an external force or a change in environmental temperature, resulting in poor electrical contact or power failure, which affects the lighting function. Accordingly, the weld-bonding is time and labor consuming to apply.

In view of this, the present inventor makes diligent studies in providing the general public with a lamp holder structure without the need to form weld-bonding so that the time required for forming bonding is omittable.

### SUMMARY OF THE INVENTION

It is an object of the present invention to provide a lamp holder structure that has two elastic conducting devices mounted under a circuit board. The elastic conducting devices are connected to the circuit board, and further connected to the power source for supplying the light-emitting device mounted inside the lamp holder structure with electric power. As a result, it is not necessary for the lamp holder structure to form weld-bonding, and the time required for forming weld-bonding is omittable, thereby increasing overall practicability and convenience.

It is another object of the present invention to provide a lamp holder structure, wherein each of two elastic conducting devices comprises a sleeve tube, a spring and a guide rod. The electrical connection status is free from affection by climate and operation condition since the springs of the elastic conducting devices has changeable lengths complying with thermal expansion and cold shrinkage. Accordingly, the guide rods are kept in contact with the electrical conducting bumps of the circuit board to connect the lamp holder structure with exterior power source for providing illumination, thereby increasing overall practicability and convenience.

It is a further object of the present invention to provide a lamp holder structure, wherein the circuit board mounted inside the lamp holder structure has a notch for polarity recognition, thereby increasing overall practicability and convenience.

In order to achieve the foregoing objects, a lamp holder structure of the present invention is comprised of: a cup-shaped base; a circuit board and two elastic conducting devices mounted inside the cup-shaped base; and at least one light-emitting device mounted on the circuit board, wherein first ends of the elastic conducting devices are mounted under the circuit board for connection with the circuit board, and seconds ends of the elastic conducting devices are extended outside of the cup-shaped base, whereby the lamp holder structure can be supplied with electric power via the elastic conducting devices for providing illumination.

The aforementioned and other objects and advantages of the present invention will be readily clarified in the description of the preferred embodiments and the enclosed drawings of the present invention.

### BRIEF DESCRIPTION OF THE DRAWINGS

FIG. 1 is an elevational view showing a first preferred embodiment of the present invention.

FIG. 2 is an elevational, decomposed view showing the first preferred embodiment of the present invention.

FIG. 3 is a schematic, cross-sectional view showing the elastic conducting devices of the first preferred embodiment of the present invention.

FIG. 4 is an elevational, decomposed view showing a second preferred embodiment of the present invention.

### DETAILED DESCRIPTION OF THE PREFERRED EMBODIMENT

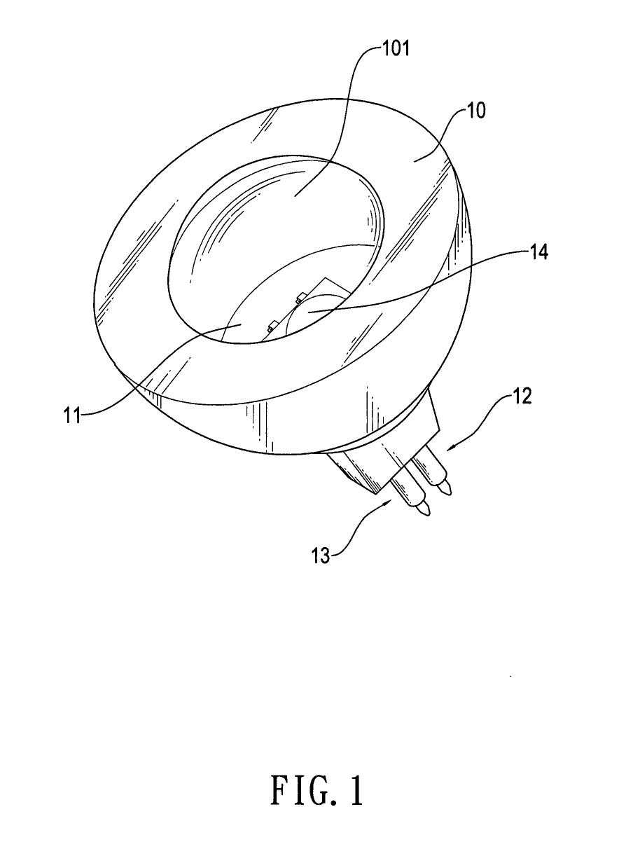

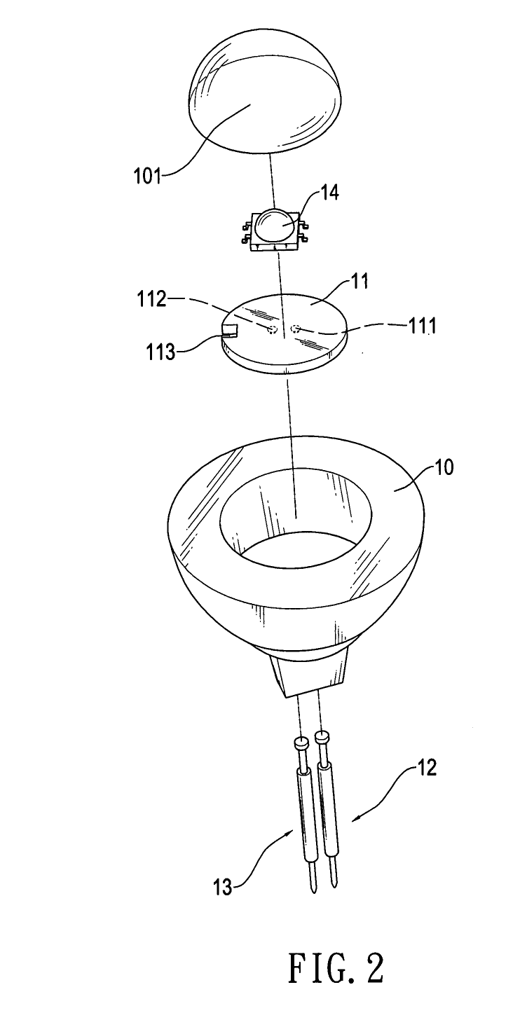

Referring to FIGS. 1 through 3, a lamp holder structure of the present invention comprises a cup-shaped base 10, and a lens 101 is disposed on the cup-shaped base 10 for collecting and refracting light beams inside the cup-shaped base 10 so as to enhance the lighting efficiency. In addition, a circuit board 11 is mounted inside the cup-shaped base 10. An electronic device and at least one light-emitting device 14 are mounted on the circuit board 11, wherein the light-emitting device 14 is a light-emitting diode or a light bulb in this preferred embodiment. In addition, two electrical conducting bumps 111, 112 are mounted under the circuit board 11 to electrically connect with anode and cathode of the circuit board 11. Besides, a notch 113 is formed on one side of the circuit board 11 for polarity recognition. Two elastic conducting devices 12, 13 are mounted under the circuit board 11. These two elastic conducting devices 12, 13 are made of electrical conducting materials. The elastic conducting devices 12, 13 comprise respective sleeve tubes 121, 131, respective springs 122, 132 and respective guide rods 124, 134, wherein the sleeve tubes 121, 131 are mounted on the inside of the cup-shaped base 10 under the circuit board 11. In addition, shaft pins 123, 133 are mounted on the respective lower portions of the sleeve tubes 121, 131 to extend outside of the cup-shaped base 10. The springs 122, 132 are mounted respectively inside the sleeve tubes 121, 131, and respective one ends of the springs 122, 132 are coupled with the guide rods 124, 134. The top portions of the guide rods 124, 134 are extended outside of the sleeve tubes 121, 131 to elastically touch the electrical conducting bumps 111, 112. When the circuit board 11 is pressed downward to couple with the inside of the cup-shaped base 10, the guide rods 124, 134 can automatically touch the electrical conducting bumps 111, 112 mounted under the circuit board 11. As a result, when the shaft pins 123, 133 are inserted into a power socket, the shaft pins 123, 133 can be electrically connected with an exterior power source for supplying the light-emitting device 14 with required electric power. In addition, in this preferred embodiment, the elastic conducting devices 12, 13 are replaceable by conducting pins that provide the same functions. To sum up, the present invention supplies the lamp holder structure with required electric power for generating lighting by electrically connecting the circuit board 11 with the exterior power source via the elastic conducting devices 12, 13.

Referring to FIGS. 1 through 3, the present invention is featured in that the elastic conducting devices 12, 13 are mounted under the circuit board 11 inside the cup-shaped base 10 and the circuit board is elastically connected with the elastic conducting devices 12, 13 so that the circuit board 11 is connectable to the exterior power source via the elastic conducting devices 12, 13 for supplying the light-emitting device 14 mounted inside the cup-shaped base 10 with the required electric power. In addition, when the circuit board 11 is pressed downward to couple with the inside of the cup-shaped base 10, the guide rods 124, 134 of the elastic conducting devices 12, 13 can automatically touch the electrical conducting bumps 111, 112 mounted under the circuit board 11. Accordingly, the circuit board 11 can be electrically connected to the exterior power source without the need to form weld-bonding. Consequently, the time required for forming weld-bonding is omittable. In addition, the elastic conducting devices 12, 13 have the springs 122, 132 mounted therein so that the guide rods 124, 134 are elastically, electrically kept in touch with the electrical conducting bumps 111, 112 of the circuit board 11 no matter whether they are in thermal expansion and cold shrinkage. Accordingly, the lamp holder structure is capable of providing illumination without affection by climate and operation condition.

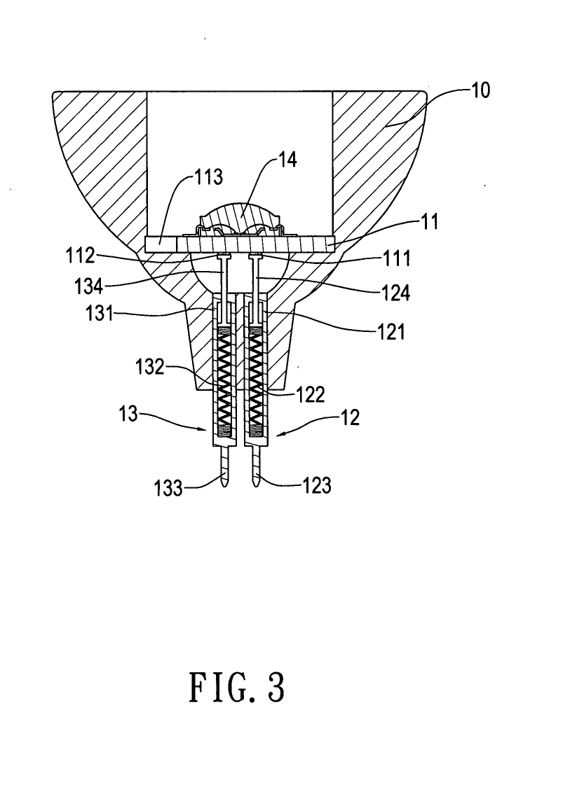

Referring to FIG. 3, the springs 122, 132 of the elastic conducting devices 12, 13 can change their lengths as a result of thermal expansion and cold shrinkage. Accordingly, the guide rods 124, 134 are kept in contact with the electrical conducting bumps 111, 112 of the circuit board 11 regardless of the change in operation temperature and environmental temperature to stably supply the light-emitting device 14 mounted inside the cup-shaped base 10 with the required electrical power.

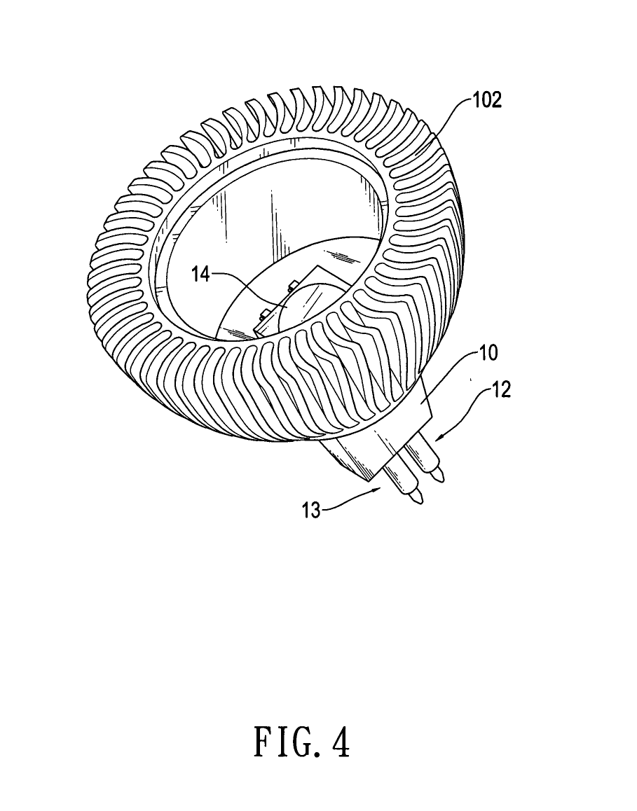

Referring further to FIG. 4, the cup-shaped base 10 of the lamp holder structure of the present invention may further have fin-shaped heat-dissipation plates 102 mounted thereon to increase the heat-dissipation area of the cup-shaped base 10 so as to dissipate the heat generated inside the cup-shaped base 10 for preventing the light-emitting device 14 or the electronic device mounted inside the cup-shaped base 10 from being damaged by high temperature.

To sum up, the present invention is capable of achieving the aforementioned objects. The present invention discloses a lamp holder structure. Therefore, this application is filed according to the patent law.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments, which do not depart from the spirit and scope of the invention.

What the invention claimed is:

1. A lamp holder structure, comprising:
a cup-shaped base;
a circuit board and two elastic conducting devices mounted inside said cup-shaped base; and
at least one light-emitting device mounted on said circuit board, wherein first ends of said elastic conducting devices are mounted under said circuit board for connection with said circuit board, and second ends of said elastic conducting devices are extended outside of said cup-shaped base, whereby said lamp holder structure can be supplied with electric power via said elastic conducting devices for providing illumination.

2. A lamp holder structure according to claim 1, wherein said at least one light-emitting device is at least one light-emitting diode.

3. A lamp holder structure according to claim 1, wherein said at least one light-emitting device is at least one light bulb.

4. A lamp holder structure according to claim 1, wherein said circuit board has a notch formed thereon for polarity recognition.

5. A lamp holder structure according to claim 1, wherein each of said elastic conducting devices comprises a sleeve tube, a spring and a guide rod, and said sleeve tube is mounted on the inside of said cup-shaped base under said circuit board, wherein said sleeve tube has a shaft pin formed on a lower portion, and said spring is mounted inside said sleeve tube, and wherein one end of said spring is coupled with said guide rod, and a top portion of said guide rod is extended outside of said sleeve tube to elastically touch said circuit board.

6. A lamp holder structure according to claim 5, further comprising two electrical conducting bumps mounted under said circuit board for electrical connection with said guide rods of said elastic conducting devices.

7. A lamp holder structure according to claim 1, wherein said elastic conducting devices are conducting pins.

8. A lamp holder structure according to claim 1, further comprising a plurality of fins mounted around the outside of said cup-shaped base for heat dissipation.

9. A lamp holder structure according to claim 1, further comprising a lens mounted on said cup-shaped base.
